(19) United States
(12) Patent Application Publication
(10) Pub. No.: US 2010/0165540 A1
(43) Pub. Date: Jul. 1, 2010

(54) CAPACITOR AND METHOD FOR FABRICATING THE SAME

(76) Inventor: Chul-Jin Yoon, Suwon-si (KR)

Correspondence Address: SHERR & VAUGHN, PLLC, 620 HERNDON PARKWAY, SUITE 320, HERNDON, VA, 20170, US

(21) Appl. No.: 12/646,642

(22) Filed: Dec. 23, 2009

(30) Foreign Application Priority Data
Dec. 31, 2008 (KR) 10-2008-0137722

(51) Int. Cl. H01G 4/002

(52) U.S. Cl. 361/301.1; 29/25.42

(57) ABSTRACT

A capacitor and method of fabricating a capacitor. A method of fabricating a capacitor may include forming a device isolation film on and/or over a semiconductor substrate, forming a polysilicon pattern on and/or over a device isolation film, forming a silicide on and/or over an upper portion of a polysilicon pattern, forming a capacitor insulating film covering a silicide, forming a pre-metal-dielectric (PMD) on and/or over a semiconductor substrate having a capacitor insulating film, and/or forming an upper metal electrode on and/or over a hole on and/or over a PMD, which may expose an insulating film opposite a region of a silicide.

The present application claims priority under 35 U.S.C. 119 to Korean Patent Application No. 10-2008-0137722 (filed on Dec. 31, 2008) which is hereby incorporated by reference in its entirety.

### BACKGROUND

Embodiments relate to semiconductor devices. Some embodiments relate to a capacitor and a method of fabricating a capacitor.

A Merged Memory Logic (MML) may have a memory cell array unit analog and/or peripheral circuits integrated on and/or over one chip. A MML may relatively improve a multimedia function, enable a relatively high device packing density integration and/or enable a relative high speed operation of a semiconductor device. There may have been research to provide a high capacity capacitor in an analog circuit which may require relative high speed operation.

A capacitor of a Polysilicon-Insulator-Polysilicon (PIP) structure may have an upper electrode and/or a lower electrode including polysilicon. An oxidation reaction may occur at interfaces of dielectric thin films of an upper electrode and a lower electrode, which may form natural oxide films to make capacitance relatively lower, and/or a depletion region formed on and/or over a polysilicon layer which may make a capacitance relatively lower. Therefore, a capacitor including a PIP structure may not be suitable for relative high speed and/or relative high frequency operation.

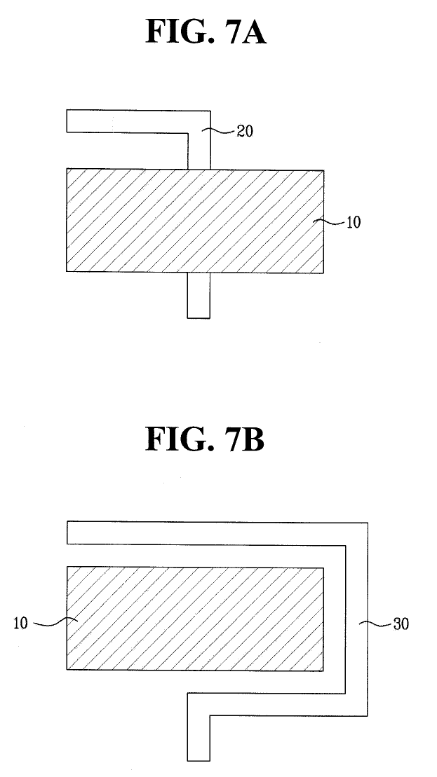

A capacitor of including a Metal-Insulator-Metal (MIM) structure may be used. However, a capacitor including a MIM structure may limit metal routings at a region where a MIM capacitor may be formed. Example FIG. 7A and FIG. 7B illustrate relations between a MIM capacitor and metal routings. Referring to FIG. 7A, MIM capacitor 10 may be routed on, and/or over, underlying metal line 20. Referring to FIG. 7B, MIM capacitor 10 and metal line 20 may be brought into contact with each other. Therefore, it may be required to route metal line 30 around MIM capacitor 10. Routing may be a relatively heavy burden to a semiconductor device which may become gradually relatively smaller. Accordingly, there is a need for a capacitor and a method of fabricating a capacitor.

### SUMMARY

Embodiments relate to semiconductor devices. Some embodiments relate to a capacitor and a method of fabricating a capacitor. According to embodiments, a capacitor and a method of fabricating the same may minimize a metal routing and/or minimize a voltage coefficient characteristic of a capacitor from becoming relatively poor, for example caused by voltage variation.

According to embodiments, a method of fabricating a capacitor may include forming a device isolation film on and/or over a semiconductor substrate. In embodiments, a method of fabricating a capacitor may include forming a polysilicon pattern on and/or over a device isolation film. In embodiments, a method of fabricating a capacitor may include forming silicide on and/or over an upper portion of a polysilicon pattern by silicidation. In embodiments, a method of fabricating a capacitor may include forming a capacitor insulating film covering a silicide. In embodiments, a method of fabricating a capacitor may include forming a pre-metal-dielectric (PMD) on and/or over a surface, which may be an entire surface of a semiconductor substrate including a capacitor insulating film. In embodiments, a method of fabricating a capacitor may include forming an upper metal electrode on and/or over a hole of a PMD which may expose an insulating film opposite a region of a silicide.

According to embodiments, a capacitor may include a device isolation film on and/or over a semiconductor substrate. In embodiments, a capacitor may include a polysilicon pattern on the device isolation film. In embodiments, a capacitor may include silicide on and/or over an upper surface of a polysilicon pattern. In embodiments, a capacitor may include a capacitor insulating film on and/or over a silicide. In embodiments, a capacitor may include a pre-metal-dielectric (PMD) on and/or over a capacitor insulating film. In embodiments, a capacitor may include an upper electrode on and/or over a capacitor insulating film opposite a region of a silicide, passed through a PMD.

### DRAWINGS

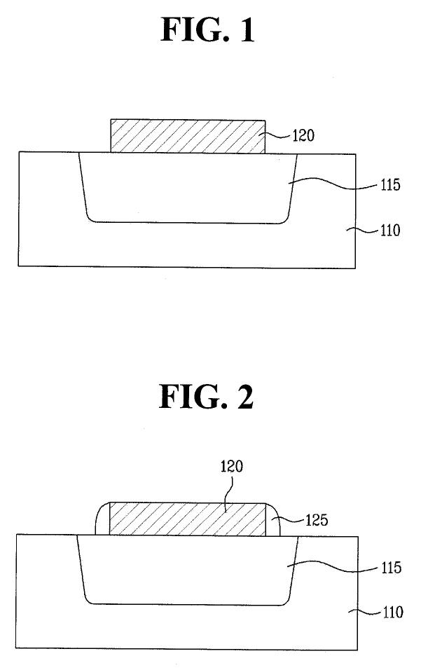

Example FIG. 1 to FIG. 6 are section views illustrating a method of fabricating a capacitor in accordance with embodiments.

Example FIG. 7A and FIG. 7B illustrate relations between Metal-Insulator-Metal capacitors and metal routings.

### DESCRIPTION

Embodiments relate to semiconductor devices. Some embodiments relate to a capacitor and a method of fabricating a capacitor. Referring to example FIG. 1 to FIG. 6, section views illustrate a method of fabricating a capacitor in accordance with embodiments. Referring to FIG. 1, device isolation film 115 may be formed on and/or over semiconductor substrate 110. According to embodiments, device isolation film 115 may define a device isolation region and/or an active region at semiconductor substrate 110. In embodiments, device isolation film 115 may be formed by Recessed-Local Oxidation of Silicon (R-LOCOS) and/or Shallow Trench Isolation (STI).

According to embodiments, implanting may be performed, which may inject impurity ions into semiconductor substrate 110 to form a well. In embodiments, polysilicon pattern 120 may be formed on and/or over device isolation film 115. In embodiments, polysilicon may be deposited on and/or over semiconductor substrate 110 having device isolation film 115. In embodiments, a ploysilicon film may be subjected to patterning, which may form polysilicon pattern 120. In embodiments, a gate pattern may be formed at an active region of semiconductor substrate 110 at substantially the same time. In embodiments, implanting may be performed on and/or over an active region to form a source and/or a drain region, for example on opposite sides of a gate pattern after a gate pattern may be formed.

Referring to FIG. 2, spacers 125 may be formed on and/or over sidewalls of polysilicon pattern 120. According to embodiments, an insulating film may be formed on and/or over semiconductor substrate 110 having polysilicon pattern 120. In embodiments, an insulating film may be etched back, which may form spacers 125. In embodiments, spacers 125 may include an oxide film and/or a nitride film.

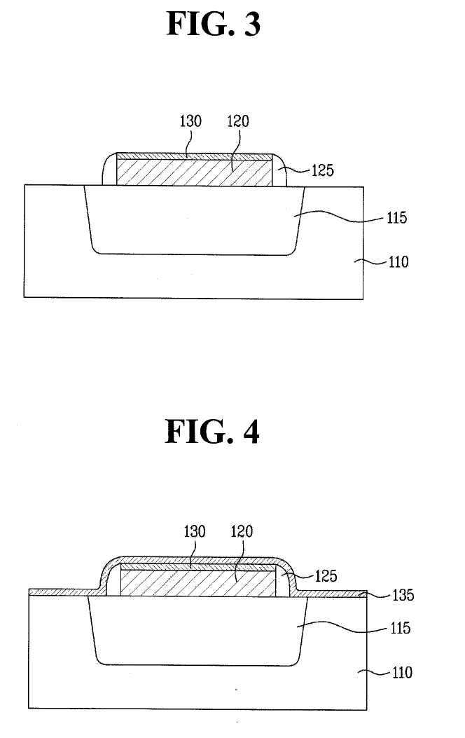

Referring to FIG. 3, silicidation may be performed, which may form silicide 130 on and/or over polysilicon pattern 120. According to embodiments, metal, for example cobalt Co and/or nickel Ni may be deposited on and/or over semiconductor substrate 110 having polysilicon pattern 120 and/or spacers 125. In embodiments, metal may be subjected to high temperature annealing, which may enable metal, such as cobalt and/or nickel, to react with an upper portion of polysilicon pattern 120. In embodiments, an upper portion of polysilicon pattern 120 may be turned into silicide 130. In embodiments, silicide may be formed at a source and/or a drain region on and/or over an active region, for example when silicidation may be performed. In embodiments, silicide source and /or drain regions may operate to make ohm's contact with a contact which may be subsequently formed. In embodiments, forming silicide 130 on and/or over polysilicon pattern 120 by silicidation may enable an upper portion of polysilicon pattern 120 to be metalized.

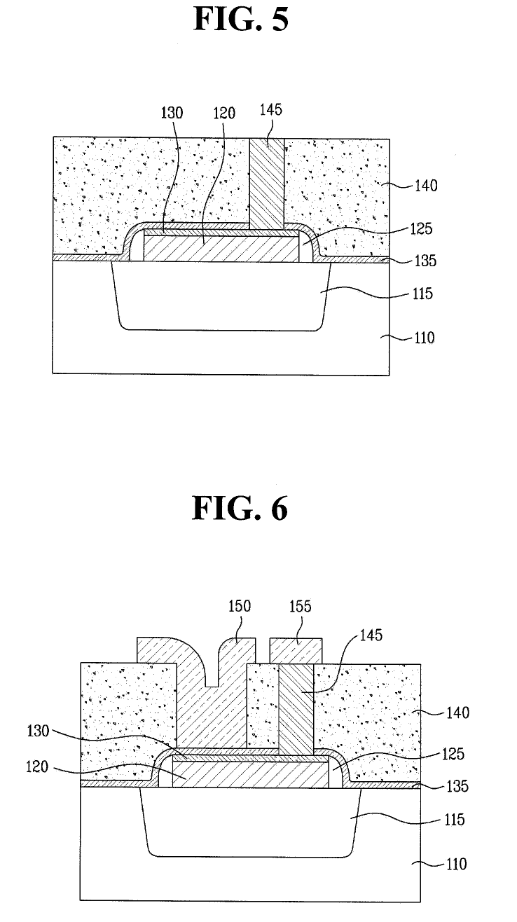

Referring to FIG. 4, an insulating film 135 may be formed on and/or over semiconductor substrate 110 including polysilicon pattern 120 and/or silicide 130. According to embodiments, insulating film 135 may include a pre-metal-dielectric (PMD) liner nitride, which may be used as an etch preventive layer at a time of patterning to form a contact hole on and/or over a deposited pre-metal-dielectric PMD. Referring to FIG. 5, PMD 140 may be formed on and/or over insulating film 135. According to embodiments, a PMD may include Boron-Phospho-Silicate Glass (BPGS) and/or PSG Phospho-Silicate Glass (PSG).

According to embodiments, contact 145 may be formed. In embodiments, contact 145 may pass through PMD 140 and/or insulating film 135. In embodiments, photolithography may be performed, which may form a photoresist pattern on and/or over PMD 140. In embodiments, PMD 140 and/or insulating film 135 may be etched using a photoresist pattern as a mask, which may form a contact hole. In embodiments, a region, for an example a first region, of silicide 130 may be exposed. In embodiments, silicide 130 may serve as an etch stop film. In embodiments, a first region may include a portion a contact may contact. In embodiments, a metal, for example tungsten, may be deposited on and/or over PMD 140, which may bury a contact hole, and/or may be flattened by Chemical Mechanical Polishing (CMP), which may form contact 145.

Referring to FIG. 6, upper metal electrode 150 may be formed on and/or over insulating film 130 on and/or over PMD 140, which may be opposite another region, for an example a second region, of silicide 130. In embodiments, a second region may not overlap a first region. In embodiments, PMD 140 may be etched selectively. In embodiments, a hole may be formed to expose a portion of insulating film 135 opposite a second region of silicide 130. In embodiments, a metal layer may be formed on and/or over PMD 140, for example until a hole may be buried. In embodiments, a metal layer may cover an upper surface of contact 145. In embodiments, a metal layer may be patterned, which may form a metal line in contact with metal electrode 150 and/or contact 145.

According to embodiments, for example as illustrated in FIG. 6, a section of a capacitor may be formed. In embodiments, a capacitor may include device isolation film 115 on and/or over semiconductor substrate 110, polysilicon pattern 120 on and/or over device isolation film 115, and/or spacers 125 on and/or over sidewalls of a polysilicon pattern and/or device isolation film 115. In embodiments, a capacitor may include silicide 130 on and/or over an upper surface of polysilicon pattern 120, capacitor insulating film 135 on and/or over an upper surface of silicide 130, and/or PMD 140 on and/or over capacitor insulating film 135. In embodiments, a capacitor may include contact 145 in contact with a region of silicide 130 passed through PMD 140 and/or capacitor insulating film 135, and/or upper electrode 150 on and/or over capacitor insulating film 135 opposite another region of silicide 130 passed through PMD 140.

According to embodiments, capacitor insulating film 135 may be formed on and/or over a surface of spacers 125 and/or a surface of an active region of semiconductor substrate 110. In embodiments a capacitor may include metal line 155 formed on and/or over PMD 140, which may be in contact with an upper surface of contact 145. In embodiments, a capacitor may include a structure having a stack of polysilicon pattern 120 including silicide 130, capacitor insulating film 135, and/or an upper electrode. In embodiments, unlike a capacitor having a structure in which a lower metal electrode, an insulating film, and/or an upper metal electrode may be stacked in succession, a capacitor in accordance with embodiments may include a structure including polysilicon pattern 120 having silicide 130, capacitor insulating film 135 and/or upper electrode 150 stacked on and/or over an upper surface of semiconductor substrate 110.

According to embodiments, a capacitor may use silicide 130 as a lower electrode, and/or PMD liner 135 as an etch stop film to form a general contact hole as an insulating film. In embodiments, a capacitor and a method of fabricating the same may include polysilicon pattern 120 having silicide 130 formed on and/or over an upper surface thereof, which may be used as a lower metal of a capacitor to substantially eliminate metal routing. Where a polysilicon may be used as a lower electrode, a voltage coefficient characteristic of a capacitor may become relatively poor due to a variation of voltage. For example, variation of resistance of a capacitor may be relatively large due to a variation of voltage. In embodiments, polysilicon pattern 120 having silicide 130 formed on and/or over an upper surface thereof may be used, such that a variation of voltage coefficient characteristic due to variation of voltage may be attenuated. In embodiments, silicide 130 may convert a portion of a polysilicon pattern into metal.

According to embodiments, a polysilicon pattern having silicide on and/or over an upper surface thereof as a lower metal of a capacitor may enable substantial elimination of metal routing. In embodiments, a voltage coefficient characteristic of a capacitor may be substantially prevented from becoming relatively poor, which may be caused by voltage variation.

It will be obvious and apparent to those skilled in the art that various modifications and variations can be made in the embodiments disclosed. Thus, it is intended that the disclosed embodiments cover the obvious and apparent modifications and variations, provided that they are within the scope of the appended claims and their equivalents.

What is claimed is:

1. A method comprising:
forming a device isolation film over a semiconductor substrate;
forming a polysilicon pattern over said device isolation film;
forming a silicide over an upper portion of said polysilicon pattern;
forming a capacitor insulating film over the silicide;
forming a pre-metal-dielectric over a surface of said semiconductor substrate including said capacitor insulating film; and
forming an upper metal electrode over a hole formed over said pre-metal-dielectric, said hole exposing said insulating film opposite a region of the silicide.

2. The method of claim 1, comprising forming a spacer over a sidewall of said polysilicon pattern.

3. The method of claim 2, wherein forming said capacitor insulating film comprises forming said capacitor insulating film over an upper portion of said polysilicon pattern, said spacer, and said semiconductor substrate.

4. The method of claim 1, comprising forming a contact over said pre-metal-dielectric and said insulating film in contact with said silicide.

5. The method of claim 4, wherein said contact comprises a metal.

6. The method of claim 1, wherein said pre-metal-dielectric comprises at least one of Boron-Phospho-Silicate Glass and Phospho-Silicate Glass.

7. The method of claim 1, wherein the silicide is formed comprising a metal.

8. The method of claim 7, wherein said metal comprises at least one of cobalt and nickel deposited over said polysilicon pattern.

9. The method of claim 7, wherein the silicide is formed comprising high temperature annealing.

10. The method of claim 1, comprising forming a metal line in contact with at least one of said metal electrode and a contact.

11. An apparatus comprising:
a device isolation film over a semiconductor substrate;
a polysilicon pattern over said device isolation film;
a silicide over an upper portion of said polysilicon pattern;
a capacitor insulating film over the silicide;
a pre-metal-dielectric over said capacitor insulating film; and
an upper metal electrode over said pre-metal-dielectric opposite a region of the silicide.

12. The apparatus of claim 11, comprising a spacer over a sidewall of said polysilicon pattern.

13. The apparatus of claimed 12, wherein said capacitor insulating film is over an upper side of said polysilicon pattern, a surface of said spacer, and a surface of an active region of said semiconductor substrate.

14. The apparatus claim 11, comprising a contact over said pre-metal-dielectric and insulating film in contact with said silicide.

15. The method of claim 14, wherein said contact comprises a metal.

16. The apparatus of claim 11, wherein said metal electrode is over a hole formed over said pre-metal-dielectric, said hole exposing said insulating film opposite another region of the silicide.

17. The apparatus of claim 11, wherein said pre-metal-dielectric comprises at least one of Boron-Phospho-Silicate Glass and Phospho-Silicate Glass.

18. The apparatus of claim 11, wherein the silicide is formed comprising a metal.

19. The apparatus of claim 18, wherein said metal comprises at least one of cobalt and nickel.

20. The apparatus of claim 11, comprising a metal line in contact with at least one of said metal electrode and a contact.
